(19) United States
(12) Patent Application Publication
(10) Pub. No.: US 2002/0023891 A1
(43) Pub. Date: Feb. 28, 2002

(54) Delivery cable circuit for a tower crane

(75) Inventors: Jean-Paul Verchere, St Nizier Sous Charlieu (FR); Olivier Gevaudant, Charlieu (FR)

Correspondence Address: OLIFF & BERRIDGE, PLC, P.O. BOX 19928, ALEXANDRIA, VA, 22320, US

(73) Assignee: POTAIN, Ecully (FR)

(21) Appl. No.: 09/909,801

(22) Filed: Jul. 23, 2001

(30) Foreign Application Priority Data
Aug. 30, 2000 (FR) 00.11095

(51) Int. Cl. B66C 23/42

(52) U.S. Cl. 212/300

(57) ABSTRACT

The invention relates to cranes with folding delivery jibs, made up of two or more successive elements articulated together. A rear delivery cable has a first end fixed to one side of the drum of the delivery winch and a second end fixed to the jib crab, this cable passing over a tensioning device carried by the jib root and comprising an articulated arm with a pulley urged by a gas spring. A front delivery cable has a first end fixed to the other side of the drum of the delivery winch and a second end fixed to a drum situated on the crab, this cable passing over a length compensating system consisting of a set of pulleys situated at the level of the articulation between the jib root and the jib tip.

### BACKGROUND OF THE INVENTION

The present invention relates to the technical field of tower cranes with delivery jibs, that is to say with a crane jib equipped with a runway track along which a crab is mounted to run, under which crab is situated the lifting hook which is moved along with this crab. The invention is more particularly concerned with a delivery cable circuit, with a device for tensioning this cable, for a crane of the kind concerned, the “delivery cable” being a motorized cable which, in this kind of crane, moves the crab along the jib.

In general, the delivery cables of tower cranes need to be taut, with a suitably controlled tension. In addition, in the case of folding jibs made up of two or more successive elements articulated together, the delivery cable circuits need to be compatible with the positions of folding.

The delivery cable may be a single cable, describing a path in the form of a loop. This cable may equally be in two parts, that is to say made up of a rear delivery cable and of a front delivery cable.

### DESCRIPTION OF THE PRIOR ART

In known embodiments of delivery cables for tower cranes there are, amongst other things, devices for automatically and controllably tensioning the cables, these being placed in the path of the rear delivery cable. These particular devices exert on the delivery cable a force of a determined value independent of the position of the crane, via a specific pulley fitted with a gas spring and mounted on the crab.

Also known are devices for compensating for the length of the delivery cable, by means of pulleys mounted on a series of links for articulation between the jib root and the jib tip, with the front delivery cable being tensioned automatically and adjustably using a mechanical spring (see document EP 0 414 646 A2).

These existing systems still have drawbacks. Hence, they are located at an intermediate point along the length of the jib (possibly on the crab, as in the first device mentioned hereinabove), which means that their dead weight creates a moment which adds to the other moments exerted on the jib. What is more, they are awkward to adjust.

More specifically, the device from the aforementioned document EP 0 414 646 A2 has the following specific drawbacks:

The compensating device involves block and tackle, the high dead weight of which creates a significant additional moment on the crane structure.

The spring of the helical type delivers a force which is proportional to its elongation, which, for a short travel, gives rise to a significant variation in force on the compensating cable, and dictates frequent adjustment.

When the crane is operating with its jib up, the load exerts a backwards force on the crab, which causes the rear delivery cable to go slack.

### SUMMARY OF THE INVENTION

The present invention sets out to improve delivery cable circuits with tensioning devices in such a way as to eliminate the aforementioned drawbacks, the objects of the invention being, more specifically:

when erecting the crane, to keep the delivery cables taut, with a constant force, while at the same time holding the crab in position, compensating for the length of the cable at the articulation between the jib elements, regardless of the relative position of these elements, and with the possibility of adjusting the pre-tension in the cables at a level that is within the reach of a person;

during use of the crane, to keep the delivery cables taut, with a constant force, without the need to make further adjustments during the life of the cables in order to compensate for their elongations, and while at the same time minimizing the moments created by the dead weight of the device. To this end, the subject of the invention is a delivery cable circuit for a tower crane with folding delivery jib made up of two or more successive elements articulated together, one of which is a jib root element and one of which is a jib tip element, along which elements a jib crab moves, with:

a rear delivery cable, a first end of which is fixed to one side of the winding drum of a motorized delivery winch and the second end of which is fixed to the jib crab, this cable passing over at least one pulley carried by the rear part of the jib root element,

a front delivery cable, a first end of which is fixed to the other side of the winding drum of the delivery winch and the second end of which is fixed to the jib crab, this cable passing over pulleys comprising at least one pulley carried by the front part of the jib tip element,

a tensioning device acting on the rear or front delivery cable to keep these two cables taut, and

for the or each articulation between two consecutive jib elements a cable-length compensation system consisting of a set of pulleys carried by the adjacent ends of these two jib elements and/or of members of the device that articulates these two jib elements together, the delivery cable circuit being essentially one wherein the tensioning device comprises an arm articulated to the jib root element, this arm carrying a pulley over which the rear delivery cable passes and at least one gas spring mounted between a point on the jib root element and a point on the articulated arm.

As a preference, the tensioning device, with articulated arm and gas spring, is mounted in the rear part of the jib root element.

According to another feature of the delivery cable circuit that is the subject of the invention, the second end of the rear delivery cable or of the front delivery cable is fixed to a tensioning drum situated on the jib crab, this drum being equipped with means for driving it and for preventing it from rotating, so as to tension this cable.

In one embodiment of the delivery cable circuit that is the subject of the invention, in the case of a device for articulating two consecutive jib elements together which comprises a horizontal articulation spindle situated approximately mid-way up these jib elements which can be nested one inside the other, a first link rod articulated to the lower front end of the rear jib element and a second link rod articulated to the lower rear end of the front jib element, the two link rods being articulated together and articulated to a folding ram, the compensation system associated with this articulation involves the front delivery cable, and it comprises:

a pulley mounted at an intermediate point on the first link rod,

a pulley mounted at the upper front end of the rear jib element,

a pulley mounted in front of the previous one, and

a pulley mounted on the second link rod.

Overall, the delivery cable circuit that is the subject of the invention has the following advantages:

The gas spring of the tensioning device develops a significant travel, with a constant thrust force, and requires no intervention in order to take up elongations of the delivery cable throughout the life of the cable. In other words, the substantial travel of the gas spring allows the tension in the rear and front delivery cables to be set “for life”.

The tensioning device, which entails no block and tackle, is situated at the root of the jib, preferably in the rear part of this jib root, and induces only a small moment as a result of its dead weight.

The tensioning drum is on the crab, at one end of one of the, rear or front, delivery cables, and allows the pretension in the delivery cables to be introduced from ground level without the jib crab having to be in a specific position on the free part of the jib in order for this operation to be performed.

Being mounted on the rear delivery cable, the tensioning device keeps the latter constantly under tension, preventing the cable from going slack under the effect of the load being lifted, when the crane is operating with its jib up.

Finally, the technical solution according to the invention compensates precisely for the length of the delivery cable, at the articulation between two consecutive jib elements, by being fitted, in particular, to a two-link-rod articulation device as described in the earlier French patent application No. 99 09688 filed on Jul. 22, 1999 in the name of the applicant company, in which case the path of the front delivery cable makes it possible to negotiate the spindle connecting the upper members of the rear jib element and of the front jib element.

### BRIEF DESCRIPTION OF THE DRAWINGS

In any case, the invention will be better understood with the aid of the description which follows, with reference to the appended schematic drawing which, by way of example, depicts one embodiment of this delivery cable circuit for a tower crane:

FIG. 1 is an overall side view of a tower crane equipped with a delivery cable circuit according to the present invention;

FIG. 2 is a detail of the front end of the jib tip of the crane of FIG. 1;

FIG. 3 is a detail of the rear end of the jib root of this crane, with the device for tensioning the delivery cable;

FIG. 4 is a detail of the central region of the jib, in the aligned position, with the articulation between the two jib elements and the crab depicted;

FIG. 5 is another detail view of the central region of the jib, corresponding to FIG. 4, but in the folded position.

### DESCRIPTION OF THE PREFERRED EMBODIMENT

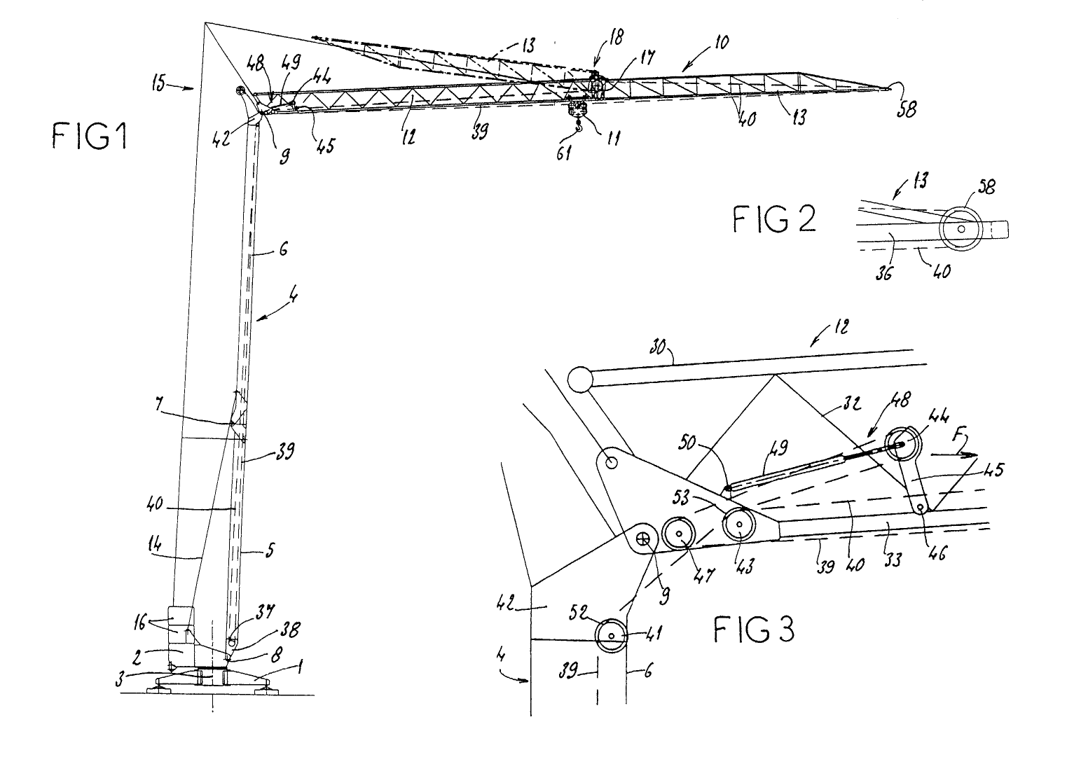

FIG. 1 schematically depicts a folding tower crane which comprises a fixed base chassis 1 on which is mounted a rotary chassis 2 that can be oriented about a vertical axis 3. The crane comprises a tower 4, made as two elements 5 and 6 articulated together about a horizontal spindle 7. The lower tower element 5 is articulated by its base, about a horizontal spindle 8, at the front of the rotary chassis 2. Articulated, about a horizontal spindle 9, to the top of the upper tower element 6, is a delivery jib 10 along which a crab 11 can move, the jib 10 in this case being made up of two elements, namely a rear element known as the jib root 12 and a front element known as the jib tip 13. As FIG. 1 shows, this crane also comprises stays 14 for standing the tower 4 up, a device 15 for retaining the jib 10, and ballast 16 carried by the rear part of the rotary chassis 2.

The jib root 12 has a triangular cross section and the jib tip 13 has a U-shaped cross section. This jib tip 13 is articulated, via its rear part, to the front part of the jib root 12, about a horizontal spindle 17 situated roughly mid-way up the jib 10. Thus, when the jib is in the folded position (see FIGS. 1, outline drawn in chain line, and FIG. 5), the two jib elements 12 and 13 are nested one inside the other, the triangular cross section of the jib root 12 fitting into the U-shaped cross section of the turned-back jib tip 13.

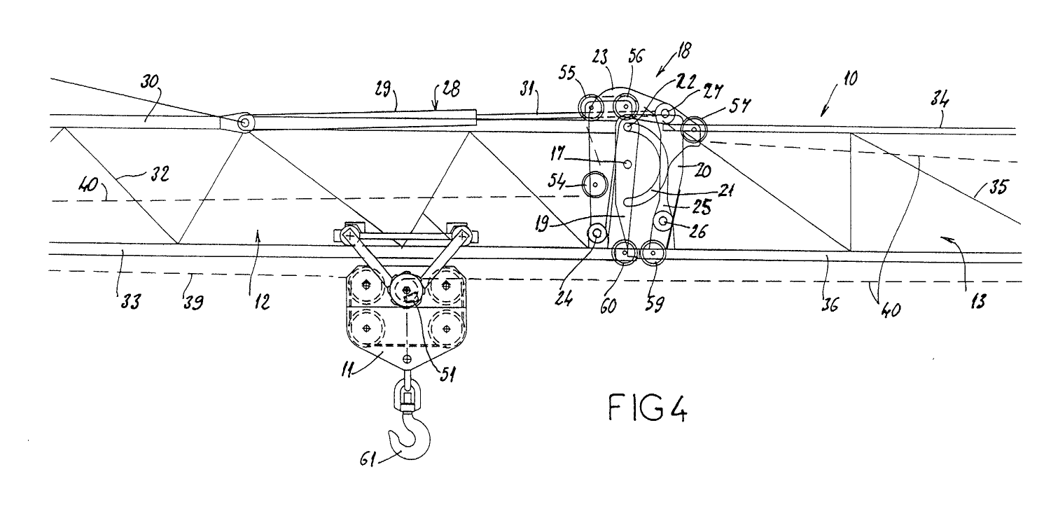

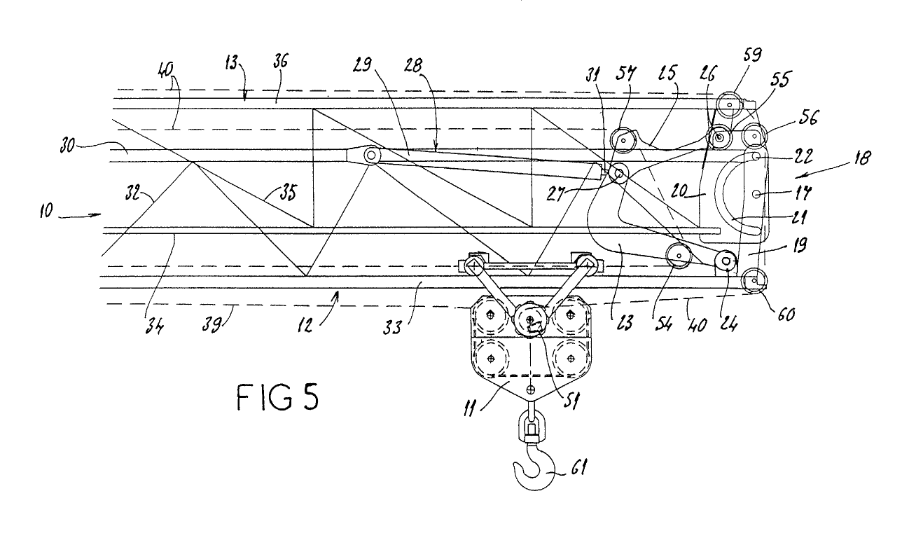

More specifically, in the example illustrated in the drawing, as shown by FIGS. 4 and 5, the jib root 12 and the jib tip 13 are connected by an articulating device 18 which, aside from the horizontal spindle 17, comprises the following elements:

in the front part of the jib root 12, two side plates 19,

in the rear part of the jib tip 13, two side plates 20, each with a slot 21 in the shape of a circular arc, (the horizontal spindle 17 passing through all the side plates 19 and 20, approximately mid-way up them),

a horizontal spindle 22 situated at the upper front end of the jib root 12 and passing through the slots 21,

a cranked double link rod 23, articulated at 24 to the lower front end of the jib root 12,

an approximately straight double link rod 25, articulated at 26 to the lower rear end of the jib tip 13,

a horizontal spindle 27 for the articulated connecting of the two link rods 23 and 25.

The aforementioned articulation device 18 is motorized by a double-acting ram 28, the body 29 of which is articulated, via its rear end, to the jib root 12 at the upper member 30, a certain distance away from the front end of this jib root 12. The rod 31 of the ram 28 is articulated, via its front end, to the spindle 27 connecting the two link rods 23 and 25.

The cranked portion of the first link rod 23 leaves space for the spindle 22 to pass; the fact that this cranked link rod 23 is configured as a double link rod, and that the second link rod 25 is also configured in this way, leaves space for the rod 31 of the ram 28 to pass freely.

The upper member 30 of the jib root 12 is connected, by latticework structures 32, to two lower members 33 of this jib root 12 which constitute part of the runway track for the crab 11. The jib tip 13 comprises two upper members 34 connected, by latticework structures 35, to two lower members 36 which constitute another part of the runway track for the crab 11.

The translational movement of the crab 11 along its runway track along the jib 10 is brought about by a motorized delivery winch equipped with a winding drum 37 and situated, in the example illustrated here, at the foot of the tower 38 (see FIG. 1, bottom). This moving of the crab 11 is via a rear delivery cable 39 and a front delivery cable 40.

The rear delivery cable 39 runs up along the tower 4 and passes over a pulley 41 (see FIG. 3) the axis of which is horizontal, carried by the top of the tower 42, then over a pulley 43, the axis of which is horizontal, carried by the rear part of the jib root 12. Next, the rear delivery cable 39 passes over a pulley 44, the axis of which is horizontal, mounted on an arm 45 articulated about a horizontal axle 46 on the jib root 12, then this cable 39 returns over a pulley 47, the axis of which is horizontal, carried by the rear end of the jib root 12, this last pulley 47 lying behind the previous pulley 44. Finally, the rear delivery cable 39 extends forward over a variable length along the jib 10 as far as the crab 11 to which its second end is fixed.

Still referring to FIG. 3, the tensioning device, denoted in its entirety by the reference 48, lies in the circuit of the rear delivery cable 39 at the rear part of the jib root 12. This tensioning device 48 comprises the aforementioned pulley 44 mounted at the end of the arm 45 articulated to the jib root 12. The tensioning device also comprises a gas spring 49 articulated between a point of attachment 50 on the jib root 12, on the one hand, and the end of the arm 45 articulated to the jib root 12, on the other hand. The gas spring 49, thus mounted, acts on the arm 45 and therefore on the pulley 44, in the direction indicated by an arrow F, in other words forward.

The front delivery cable 40 has a first end fixed to the other side of the winding drum 37 of the delivery winch, while its other end is fixed to a tensioning drum 51 situated on the crab 11, the circuit of said cable 40 being as follows (see FIGS. 1, 2, 3 and 4):

The front delivery cable 40 runs up along the tower 4 and passes over a pulley 52, the axis of which is horizontal, carried by the top of the tower 42, then over a pulley 53, the axis of which is horizontal, carried by the rear part of the jib root 12. The two pulleys 52 and 53 may be coaxial with, respectively, the corresponding two pulleys 41 and 43 over which the rear delivery cable 39 passes.

From the pulley 53, the front delivery cable 40 runs forward, along the jib root 12 and over the entire length thereof as far as a pulley 54, the axis of which is horizontal, mounted on the cranked link rod 23 belonging to the device 18 that articulates the jib root 12 and the jib tip 13 together. The cable 40 then passes over a pulley 55, the axis of which is horizontal, mounted at the upper front end of the jib root 12, then over another pulley 56, the axis of which is horizontal, mounted in front of the previous one and near to it, still at the upper front end of the jib root 12.

From there, the front delivery cable 40 passes over a pulley 57, the axis of which is horizontal, mounted on the other link rod 25 of the articulation device 18, namely the link rod 25 articulated to the rear end of the jib tip 13. The cable 40 then runs forward, along the jib tip 13 and along the entire length thereof as far as a pulley 58, the axis of which is horizontal, carried by the front end of the jib tip 13 (see detail in FIG. 2).

Returned by the pulley 58, the front delivery cable 40 then runs backward along the jib tip 13 and along the entire length thereof as far as a pulley 59, the axis of which is horizontal, situated at the lower rear end of the jib tip 13 (this being when the crab 11 is on the jib root 12, as shown in FIGS. 4 and 5).

The circuit of the front delivery cable 40 comprises a last pulley 60, the axis of which is horizontal, carried by the lower front end of the jib root 12.

At the device 18 that articulates the jib root 12 and the jib tip 13 together, the two pulleys 54 and 57 mounted respectively on the two link rods 23 and 24 form, with the other two pulleys 55 and 56 mounted on the upper member 30 of the jib root 12, a system that compensates for the length of the cable. By passing over these two pulleys 55 and 56, the front delivery cable 40 negotiates the spindle 22 connecting the respective upper members 30 and 34 of the jib root 12 and of the jib tip 13, both when the jib 10 is in the aligned position (FIG. 4) and when it is in its folded position (FIG. 5).

As mentioned earlier, the second end of the front delivery cable 40 is fixed to a drum 51 carried by the crab 11. The drum 51 is equipped with a square drive on its rotation spindle, which can be turned using a wrench, means also being provided for preventing this drum from rotating. These means allow the cables 39 and 40 to be pretensioned (as detailed later) and also allow storage of any excess length of cable there might be if the length of the jib 10 is reduced.

The way in which the devices described above work is as follows:

1. Pretensioning the cable:

This operation is performed on the crane folded horizontally, the jib 10 itself being either folded or aligned. The crab 11 is then placed at the front end of the jib root 12, if the jib 10 is folded, or placed on the jib tip 13 at any point along the length of that element, if the jib 10 is aligned.

As the crab 11 therefore lies within reach of a person, the operator winds the front delivery cable 40 onto the tensioning drum 51 situated on this crab 11, with the help of the wrench and the driving square. The crab 11 is thus moved toward the front of the jib 10, which tensions the rear delivery cable 39. While this is happening, the rear delivery cable 39, passing amongst other things over the pulley 44 carried by the end of the arm 45, causes this arm 45 to pivot in the opposite direction to the arrow F, in other words backward. The pivoting of the arm 45 compresses the gas spring 49 to its maximum compressive travel.

When this operation has been completed, the gas spring 49 exerts thrust on the pulley 44 carried by the arm 45. As the crab 11 is free to move along its runway track along the jib 10, the pulley 44 tensions the rear delivery cable 39 and the front delivery cable 40 with the same tensile force in both cables.

2. Maintaining tension while the crane is operating:

The rear 39 and front 40 delivery cables lengthen, while the crane is in use, under the effect of the loads lifted by the hook 61 and delivered by the crab 11. When these cables lengthen, the gas spring 49 reacts on the arm 45 with a constant thrusting force which permanently maintains tension of a constant value in the rear 39 and front 40 delivery cables.

3. Folding the jib:

The folding of the jib 10 from its aligned position (FIG. 4) is brought about by the ram 28 which acts on the link rods 23 and 25 of the device 18 that articulates the jib root 12 and the jib tip 13 together. With the crab 11 located at some point on the jib root 12, this folding operation involves only the front delivery cable 40, more specifically in the region of the compensating system.

When the jib 10 is being folded, going from the position in FIG. 4 to the one in FIG. 5, the relative movement of the two link rods 23 and 25, respectively carrying the pulleys 54 and 57, shortens the length of the bit of cable situated between these two pulleys 54 and 57 by a distance equal to the increase in the length of the bit of cable between the two pulleys 59 and 60 situated facing each other when the jib 10 is aligned but moving away from one another during folding. In consequence, the length of the bit of front delivery cable 40 between the pulley 53 carried by the jib root 12 and the tensioning drum 51 situated on the crab 11 does not vary, particularly in the region of the articulating device 18.

There is therefore precise compensation for the length of the cable and, in consequence, the crab 11 remains immobile and stays in the position initially occupied, during this operation of folding the jib 10.

Furthermore, during and after this operation, the rear 39 and front 40 delivery cables remain constantly taut, with the same tensile force as a result of the gas spring.

4. Unfolding the jib:

Let us now consider the operation, which is the reverse of the previous one, which consists in unfolding the jib 10 from its folded position (FIG. 5), this operation also being brought about by the ram 28. Cable length is therefore compensated for in a similar way, at the articulation device 18, and leads to the same results, namely the crab 11 being kept in position and the tension in the delivery cables 39 and 40 being maintained.

5. Operating the crane with the jib partially folded:

Bringing the crane into such a position corresponds to part of the operation of folding the jib 10, described in paragraph 3 above. This phase is performed in the same way with length compensation for the front delivery cable 40.

Furthermore, while the crane is operating with the jib 10 partially folded, the tension in the rear 39 and front 40 delivery cables is maintained, according to the description given in paragraph 2 above.

As goes without saying, the invention is not restricted to the sole embodiment of this delivery cable circuit for a tower crane which was described hereinabove by way of example: on the contrary, it encompasses all alternative embodiments and applications thereof which follow the same principle. Thus, in particular, the following would not be departing from the scope of the invention:

if the single gas spring 49 in the tensioning device 48 were replaced by two or more gas springs, mounted and acting in parallel;

if the position of the delivery winch on the crane were modified, it being possible for this winch to be placed also at the top of the tower 42, or on the jib root 12 or alternatively mid-way along the jib 10;

if application of the invention were extended to cover a crane with a jib having any number of elements, for example, three elements, in any shape, with a cable length compensating system at each articulation between two consecutive jib elements;

if the cable circuit were adapted, particularly in its part constituting the compensation system, to suit the specifics of the device articulating jib elements together, it being possible for this articulating device to be of any type.

1. A delivery cable circuit for a tower crane with folding delivery jib made up of two or more successive elements articulated together, one of which is a jib root element and one of which is a jib tip element, along which elements a jib crab moves, with:
a rear delivery cable, a first end of which is fixed to one side of the winding drum of a motorized delivery winch and the second end of which is fixed to the jib crab, this cable passing over at least one pulley carried by the rear part of the jib root element,
a front delivery cable, a first end of which is fixed to the other side of the winding drum of the delivery winch and the second end of which is fixed to the jib crab, this cable passing over pulleys comprising at least one pulley carried by the front part of the jib tip element,
a tensioning device acting on the rear or front delivery cable to keep these two cables taut, and
for the or each articulation between two consecutive jib elements, a cable-length compensation system consisting of a set of pulleys carried by the adjacent ends of these two jib elements and/or of members of the device that articulates these two jib elements together,
wherein the tensioning device comprises an arm articulated to the jib root element, this arm carrying a pulley over which the rear delivery cable passes and at least one gas spring mounted between a point on the jib root element and a point on the articulated arm.

2. The delivery cable circuit for a tower crane as claimed in claim 1, wherein the tensioning device, with articulated arm and gas spring, is mounted in the rear part of the jib root element.

3. The delivery cable circuit for a tower crane as claimed in claim 1 or 2, wherein the second end of the rear delivery cable or of the front delivery cable is fixed to a tensioning drum situated on the jib crab, this drum being equipped with means for driving it and for preventing it from rotating, so as to tension this cable.

4. The delivery cable circuit for a tower crane as claimed in any of claims 1 to 3, wherein, in the case of a device for articulating two consecutive jib elements together which comprises a horizontal articulation spindle situated approximately mid-way up these jib elements which can be nested one inside the other, a first link rod articulated to the lower front end of the rear jib element and a second link rod articulated to the lower rear end of the front jib element, the two link rods being articulated together and articulated to a folding ram, the compensation system associated with this articulation involves the front delivery cable, and this system comprises:
a pulley mounted at an intermediate point on the first link rod,
a pulley mounted at the upper front end of the rear jib element,
a pulley mounted in front of the previous one, and
a pulley mounted on the second link rod.
